(19) United States
(12) Patent Application Publication
(10) Pub. No.: US 2024/0268930 A1
(43) Pub. Date: Aug. 15, 2024

(54) INDICATOR AND DENTAL APPLIANCE HAVING SAME

(71) Applicant: WUXI EA MEDICAL INSTRUMENTS TECHNOLOGIES LIMITED, Wuxi, Jiangsu (CN)

(72) Inventors: Shida LYU, Wuxi (CN); Shangjie CHU, Wuxi (CN); Lei HUANG, Wuxi (CN)

(73) Assignee: WUXI EA MEDICAL INSTRUMENTS TECHNOLOGIES LIMITED, Wuxi, Jiangsu (CN)

(21) Appl. No.: 18/290,352

(22) PCT Filed: May 10, 2022
(86) PCT No.: PCT/CN2022/091845

§ 371 Date: Nov. 13, 2023

(30) Foreign Application Priority Data
May 11, 2021 (CN) 202110511032.8
May 11, 2021 (CN) 202121001022.1
May 11, 2021 (CN) 202121004424.7
May 11, 2021 (CN) 202121004480.0

(51) Int. Cl. A61C 7/08

(52) U.S. Cl. CPC A61C 7/08; A61C 2204/007

(57) ABSTRACT

The present invention discloses an indicator and a dental appliance having the same. The indicator is used for a dental appliance. The indicator includes a first indicator and a second indicator that are stacked, the first indicator includes a first pattern layer, the second indicator includes a second pattern layer, and an active substance in an oral cavity sequentially penetrates through the first indicator and the second indicator and acts on the first pattern layer and the second pattern layer to sequentially present patterns. The indicator and the dental appliance of the present invention can optimize an indication effect and improve wearing compliance.

### CROSS-REFERENCE TO RELATED APPLICATIONS

This application is the National Phase of PCT International Application No. PCT/CN2022/091845, filed on May 10, 2022, which claims priority to Chinese Patent Application No. 202110511032.8, filed on May 11, 2021 and entitled “INDICATOR AND DENTAL APPLIANCE HAVING SAME”, Chinese Patent Application No. 202121004480.0, filed on May 11, 2021 and entitled “INDICATOR AND DENTAL APPLIANCE HAVING SAME”, Chinese Patent Application No. 202121004424.7, filed on May 11, 2021 and entitled “INDICATOR AND DENTAL APPLIANCE HAVING SAME”, and Chinese Patent Application No. 202121001022.1, filed on May 11, 2021 and entitled “INDICATOR AND DENTAL APPLIANCE HAVING SAME”, which are incorporated herein by reference in their entireties.

### TECHNICAL FIELD

The present invention relates to the technical field of orthodontics, and in particular, to an indicator and a dental appliance having the same.

### BACKGROUND

In the field of dentistry, many treatments need to be completed by wearing dental appliances in an oral cavity, for example, an orofacial muscle training device and a shell-shaped orthodontic appliance that is based on a polymer material and that is becoming increasingly popular due to advantages such as aesthetics, convenience, and ease of cleaning.

During a treatment, a sufficient dental appliance wearing time is an important guarantee for the treatment. However, due to the discomfort during wearing orthodontics and the characteristic of dental appliances that can be removed at any time, the patient's wearing compliance is a problem that plagues clinicians.

Therefore, in an aspect, suitable means are needed to improve patient's compliance, and in another aspect, suitable means are needed to indicate whether the dental appliance has been worn for a sufficient time.

The above-mentioned problem is a problem that those skilled in the art need to solve urgently.

### SUMMARY

Objectives of the present invention are to provide an indicator and a dental appliance having the same, and the indicator can optimize an indication effect and improve wearing compliance.

To achieve one of the foregoing inventive objectives, an embodiment of the present invention provides an indicator, used for a dental appliance, where the indicator includes a first indicator and a second indicator that are stacked, the first indicator includes a first pattern layer, the second indicator includes a second pattern layer, and an active substance in an oral cavity sequentially penetrates through the first indicator and the second indicator and acts on the first pattern layer and the second pattern layer to sequentially present patterns.

As a further improvement of an embodiment of the present invention, the first pattern layer is connected to the second pattern layer.

As a further improvement of an embodiment of the present invention, the first pattern layer and the second pattern layer include different starch-iodine inclusion complexes.

As a further improvement of an embodiment of the present invention, the first indicator further includes a first reaction layer for blocking the first pattern layer, the second indicator further includes a second reaction layer for blocking the second pattern layer, and the active substance controls the first reaction layer and the second reaction layer to sequentially become transparent and sequentially expose the first pattern layer and the second pattern layer.

As a further improvement of an embodiment of the present invention, the first reaction layer and the second reaction layer are configured to become transparent when the adsorbed active substance reaches a saturated state.

As a further improvement of an embodiment of the present invention, the first pattern layer and the second pattern layer are configured to present patterns under the action of the active substance.

As a further improvement of an embodiment of the present invention, the first indicator further includes a first adsorption layer connected to the first reaction layer, and the second indicator further includes a second adsorption layer connected to the second reaction layer; and when the active substance adsorbed by the first adsorption layer reaches a saturated state, the active substance penetrates into the first reaction layer, and when the active substance adsorbed by the second adsorption layer reaches a saturated state, the active substance penetrates into the second reaction layer.

As a further improvement of an embodiment of the present invention, the first adsorption layer, the first reaction layer, the first pattern layer, the second adsorption layer, the second reaction layer, and the second pattern layer are sequentially stacked.

As a further improvement of an embodiment of the present invention, both the first adsorption layer and the second adsorption layer are transparent layers.

As a further improvement of an embodiment of the present invention, the indicator further includes an encapsulation layer for encapsulating the first indicator and the second indicator.

As a further improvement of an embodiment of the present invention, the encapsulation layer is provided with a through-hole for connecting the first indicator to the oral cavity.

As a further improvement of an embodiment of the present invention, the encapsulation layer is made of a material for isolating the active substance.

As a further improvement of an embodiment of the present invention, at least part of the encapsulation layer is made of a material penetrable to the active substance.

As a further improvement of an embodiment of the present invention, an outer contour of the second pattern layer is located on an outer side of an outer contour of the first pattern layer.

To achieve one of the foregoing inventive objectives, an embodiment of the present invention provides a dental appliance, worn in an oral cavity and including the indicator according to any one of the foregoing technical solutions.

As a further improvement of an embodiment of the present invention, the dental appliance includes a dental appliance body and the indicator arranged on the dental appliance body, and the dental appliance body forms a cavity for receiving teeth.

As a further improvement of an embodiment of the present invention, the first indicator is located on a side of the second indicator away from the teeth.

As a further improvement of an embodiment of the present invention, the first indicator and the second indicator are arranged side by side in a teeth arrangement direction.

As a further improvement of an embodiment of the present invention, the dental appliance is a shell-shaped orthodontic appliance or an orofacial muscle training appliance.

To achieve one of the foregoing inventive objectives, an embodiment of the present invention provides an indicator, used for a dental appliance, where the indicator includes an adsorption layer and a display layer, and when the adsorption layer adsorbs an active substance in an oral cavity and reaches a saturated state, the active substance penetrates through the adsorption layer and into the display layer, and the active substance acts on the display layer to present a pattern.

As a further improvement of an embodiment of the present invention, the display layer includes a pattern layer and a reaction layer for blocking the pattern layer, and the active substance controls the reaction layer to become transparent and expose the pattern layer.

As a further improvement of an embodiment of the present invention, the reaction layer is configured to become transparent when the adsorbed active substance reaches a saturated state.

As a further improvement of an embodiment of the present invention, the pattern layer is configured to present a pattern under the action of the active substance.

As a further improvement of an embodiment of the present invention, the adsorption layer is connected to the reaction layer, and the reaction layer is located between the adsorption layer and the pattern layer, or the reaction layer is located on a peripheral edge of the adsorption layer.

As a further improvement of an embodiment of the present invention, at least one of the adsorption layer, the reaction layer, and the pattern layer is a multi-layer structure.

As a further improvement of an embodiment of the present invention, the adsorption layer is a transparent layer.

As a further improvement of an embodiment of the present invention, the indicator further includes an encapsulation layer for encapsulating the adsorption layer and the display layer.

As a further improvement of an embodiment of the present invention, the encapsulation layer is provided with a through-hole for connecting the adsorption layer to the oral cavity.

As a further improvement of an embodiment of the present invention, the adsorption layer extends into the through-hole.

As a further improvement of an embodiment of the present invention, the encapsulation layer is made of a material for isolating the active substance.

As a further improvement of an embodiment of the present invention, at least part of the encapsulation layer is made of a material penetrable to the active substance.

As a further improvement of an embodiment of the present invention, the encapsulation layer encapsulates an upper surface, a peripheral edge, and a lower surface of the adsorption layer and the display layer.

To achieve one of the foregoing inventive objectives, an embodiment of the present invention provides a dental appliance, worn in an oral cavity and including the indicator according to any one of the foregoing technical solutions.

As a further improvement of an embodiment of the present invention, the dental appliance includes a dental appliance body and the indicator arranged on the dental appliance body, and the dental appliance body forms a cavity for receiving teeth.

As a further improvement of an embodiment of the present invention, the indicator is arranged on a side of the dental appliance body close to a tongue side, and/or the indicator is arranged on a side of the dental appliance body close to a lip side.

As a further improvement of an embodiment of the present invention, the dental appliance includes a plurality of indicators that are stacked.

As a further improvement of an embodiment of the present invention, the dental appliance is a shell-shaped orthodontic appliance or an orofacial muscle training appliance.

To achieve one of the foregoing inventive objectives, an embodiment of the present invention provides an indicator, used for a dental appliance, where the indicator includes a pattern layer and a scale, the pattern layer generates a changed area under the action of an active substance in an oral cavity, and the scale is used for indicating location information of the changed area.

As a further improvement of an embodiment of the present invention, the scale is provided with a mark for indicating a junction location between the changed area and an unchanged area.

As a further improvement of an embodiment of the present invention, the indicator further includes an encapsulation layer for encapsulating at least the pattern layer.

As a further improvement of an embodiment of the present invention, the encapsulation layer is provided with a through-hole for connecting the pattern layer to the oral cavity.

As a further improvement of an embodiment of the present invention, the encapsulation layer is made of a material for isolating the active substance.

As a further improvement of an embodiment of the present invention, at least part of the encapsulation layer is made of a material penetrable to the active substance.

As a further improvement of an embodiment of the present invention, the pattern layer includes a starch-iodine inclusion complex.

As a further improvement of an embodiment of the present invention, the pattern layer includes a first pattern layer and a second pattern layer that are connected to each other.

To achieve one of the foregoing inventive objectives, an embodiment of the present invention provides a dental appliance, worn in an oral cavity and including the indicator according to any one of the foregoing technical solutions.

As a further improvement of an embodiment of the present invention, the dental appliance includes a dental appliance body and the indicator arranged on the dental appliance body, and the dental appliance body forms a cavity for receiving teeth.

As a further improvement of an embodiment of the present invention, the indicator is mounted on an outer surface of the dental appliance body, the pattern layer changes color in a first direction and generates the changed area, and the first direction is parallel to the outer surface of the dental appliance body.

As a further improvement of an embodiment of the present invention, the first direction is a teeth arrangement direction.

As a further improvement of an embodiment of the present invention, the dental appliance is a shell-shaped orthodontic appliance or an orofacial muscle training appliance.

Compared with the prior art, an embodiment of the present invention has the following beneficial effects: An indicator and a dental appliance of an embodiment of the present invention can optimize an indication effect and improve wearing compliance.

### BRIEF DESCRIPTION OF THE DRAWINGS

FIG. 1 is a schematic diagram of a dental appliance according to an embodiment of the present invention;

FIG. 2 is a schematic diagram of an indicator according to a first specific example in a first embodiment of the present invention:

FIG. 3 is a schematic diagram of a dental appliance according to a first specific example in a first embodiment of the present invention:

FIG. 4 is a schematic diagram of a dental appliance according to another example in a first embodiment of the present invention:

FIG. 5 is a schematic diagram of an indicator according to another example in a first embodiment of the present invention:

FIG. 6 is a schematic diagram of a dental appliance according to a second specific example in a first embodiment of the present invention:

FIG. 7 is a schematic diagram of a dental appliance according to a third specific example in a first embodiment of the present invention:

FIG. 8 is a schematic diagram of a dental appliance according to a fourth specific example in a first embodiment of the present invention:

FIG. 9 is a schematic diagram of a dental appliance according to a fifth specific example in a first embodiment of the present invention:

FIG. 10 is a schematic diagram of a dental appliance according to a sixth specific example in a first embodiment of the present invention:

FIG. 11 is a schematic diagram of an indicator according to a first specific example in a second embodiment of the present invention:

FIG. 12 is a schematic diagram of a dental appliance according to a first specific example in a second embodiment of the present invention:

FIG. 13 is a schematic diagram of a dental appliance according to another example in a second embodiment of the present invention:

FIG. 14 is a schematic diagram of a dental appliance according to a second specific example in a second embodiment of the present invention:

FIG. 15 is a top view corresponding to FIG. 14;

FIG. 16 is a schematic diagram of a dental appliance according to a third specific example in a second embodiment of the present invention:

FIG. 17 is a top view corresponding to FIG. 16;

FIG. 18 is a schematic diagram of a dental appliance according to a fourth specific example in a second embodiment of the present invention:

FIG. 19 is a top view corresponding to FIG. 18:

FIG. 20 is a schematic diagram of a dental appliance according to a fifth specific example in a second embodiment of the present invention:

FIG. 21 is a schematic diagram of an indicator according to a first specific example in a third embodiment of the present invention:

FIG. 22 is a schematic diagram of a dental appliance according to a first specific example in a third embodiment of the present invention:

FIG. 23 is a schematic diagram of a dental appliance according to a second specific example in a third embodiment of the present invention:

FIG. 24 is a schematic diagram of a dental appliance according to a third specific example in a third embodiment of the present invention; and

FIG. 25 is a top view corresponding to FIG. 24.

### DETAILED DESCRIPTION

The present invention is described in detail below with reference with the specific embodiments shown in the accompanying drawings. However, these embodiments do not limit the present invention, and structural, methodological, or functional transformations made by a person of ordinary skill in the art according to these embodiments are included in the protection scope of the present invention.

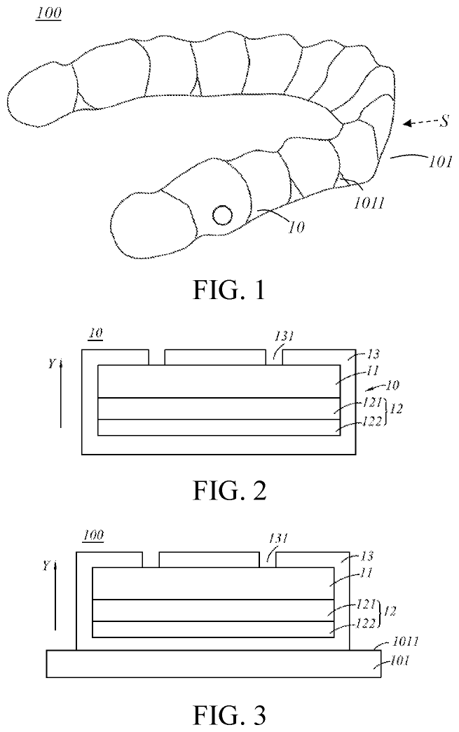

Refer to FIG. 1 and FIG. 2, which show a dental appliance 100 and an indicator 10 of an embodiment of the present invention. The indicator 10 is used for the dental appliance 100.

The dental appliance 100 is worn in an oral cavity. This embodiment is described using an example in which the dental appliance 100 is a shell-shaped orthodontic appliance. In another embodiment, the dental appliance 100 may alternatively be another dental appliance that needs to be worn for a specific time in the oral cavity, for example, an orofacial muscle training appliance.

The dental appliance 100 includes a dental appliance body 101 and the indicator 10 arranged on the dental appliance body 101, the dental appliance body 101 forms a cavity S for receiving teeth, and the dental appliance body 101 is generally made of a transparent material.

The cavity S for receiving teeth of the dental appliance 100 has a geometrical form for re-positioning patient's teeth from a first layout to a second layout. For example, the geometrical form of the cavity S of the dental appliance 100 may be determined based on the second layout of the patient's teeth, or the geometrical form of the cavity S of the dental appliance 100 may be substantially consistent with the second layout of the patient's teeth.

In this embodiment, the indicator 10 may be an independently manufactured product, and is subsequently used for the dental appliance 100.

The indicator 10 is arranged on a side of the dental appliance body 101 close to a tongue side, and/or the indicator 10 is arranged on a side of the dental appliance body 101 close to a lip side.

The quantity and locations of indicators 10 are not limited, and may be determined according to an actual situation, and it is only necessary to ensure that the indicator 10 can come into contact with an oral cavity environment.

Refer to FIG. 2 and FIG. 3, which are schematic diagrams of an indicator 10 and a dental appliance 100 having an indicator 10 according to a first embodiment of the present invention.

The indicator 10 includes an adsorption layer 11 and a display layer 12, and when the adsorption layer 11 adsorbs an active substance in an oral cavity and reaches a saturated state, the active substance penetrates through the adsorption layer 11 and into the display layer 12, and the active substance acts on the display layer 12 to present a pattern.

The active substance in the oral cavity is a change causing factor that can control the display layer 12 to present a pattern, and the active substance is, for example, saliva in the oral cavity.

That “the display layer 12 presents a pattern” means that the state of the display layer 12 is changed. For example, the volume, the shape, the color, the pattern, and the like of the display layer 12 are changed, and the changes can be intuitively observed.

In this embodiment, when the dental appliance 100 is not fully worn, the active substance adsorbed by the adsorption layer 11 does not reach the saturated state, the active substance cannot penetrate into the display layer 12, that is, the display layer 12 does not present a pattern, and the display layer 12 still maintains the initial unchanged state.

Then, as the wearing time increases, when the dental appliance 100 is fully worn, the active substance adsorbed by the adsorption layer 11 reaches the saturated state, the active substance penetrates through the adsorption layer 11 and into the display layer 12, and the active substance acts on the display layer 12 to present a pattern. That is to say, when the pattern presented by the display layer 12 is observed, it is determined that the dental appliance 100 has been worn for a sufficient time.

The adsorption layer 11 of this embodiment may continuously adsorb the active substance, for example, the adsorption layer 11 continuously adsorbs saliva. Only when the adsorption layer 11 reaches the saturated state, the active substance interacts with the display layer 12. That is to say, when the adsorption layer 11 has not reached the saturated state, the display layer 12 is always unchanged. Only when the adsorption layer 11 reaches the saturated state, the display layer 12 is changed, which can greatly improve indication accuracy of the indicator 10.

Compared with the solution in which the indicator 10 is always changed in the entire wearing process, only when the adsorption layer 11 reaches the saturated state, the indicator 10 of this embodiment has a state change, and the time in which the adsorption layer 11 reaches the saturated state is controllable, for example, by controlling the material, the thickness, or the like of the adsorption layer 11. In an aspect, the wearing time can be precisely indicated by controlling the time in which the adsorption layer 11 reaches the saturated state, and in another aspect, a situation in which an erroneous determination occurs because the indicator 10 is always changed can be avoided.

In this embodiment, the adsorption layer 11 may be made of, for example, a material with a large water absorption rate, such as polyurethane, polyvinyl alcohol, or silica gel desiccant.

The display layer 12 may be made of a material whose state is changed under the action of the active substance in the oral cavity. For example, the material included in the display layer 12 changes color under the influence of the active substance, and the changing color may be becoming a color from being transparent, or may be becoming transparent from a color, or may be becoming from a color to another color. The color change of display layer 12 can be intuitively observed.

Alternatively, the material included in the display layer 12 presents a hidden pattern under the influence of the active substance, for example, presents a specific color, a smile pattern, a corresponding text, or a product trademark.

In this embodiment, the indicator 10 further includes an encapsulation layer 13 for encapsulating the adsorption layer 11 and the display layer 12, the encapsulation layer 13 is provided with a through-hole 131 for connecting the adsorption layer 11 to the oral cavity, and the active substance in the oral cavity comes into contact with the adsorption layer 11 through the through-hole 131.

The “encapsulating” means that the encapsulation layer 13 surrounds part or all of the structure of the indicator 10, thereby controlling a path in which the active substance in the oral cavity acts on the indicator 10, to prevent the active substance from directly coming into contact with the display layer 12 to change the display layer 12.

In addition, the encapsulation layer 13 is made of a material for isolating the active substance, and the through-hole 131 has a small size. In a washing process of the dental appliance 100, it is difficult for washing water to penetrate through the encapsulation layer 13 and enter the indicator 10, that is, a factor of washing the dental appliance 100 or the like may be prevented from affecting indication accuracy of the indicator 10.

In this embodiment, the encapsulation layer 13 may be a porous polymer film, for example, a porous polymer film made of a polymer such as polyurethane, silica gel, or polyacrylic acid, a penetration amount of the active substance may be adjusted by controlling the quantity and size of through-holes 131 of the encapsulation layer 13 (that is, controlling the porosity of the encapsulation layer 13), and then the time in which the adsorption layer 11 reaches the saturated state is further controlled.

In this embodiment, the encapsulation layer 13 encapsulates an upper surface, a peripheral edge, and a lower surface of the adsorption layer 11 and the display layer 12. That is to say, the encapsulation layer 13 wraps entire outer surfaces of the adsorption layer 11 and the display layer 12, and the through-hole 131 is formed in only an area corresponding to the adsorption layer 11. In this way, the indicator 10 having the encapsulation layer 13 may be used as an independent product and is insusceptible to an external environment, and the indicator 10 as an independent product may be flexibly applied to various dental appliances.

In another embodiment, a lateral surface of the display layer 12 away from the adsorption layer 11 may alternatively not be encapsulated by the encapsulation layer 13. For example, removable release paper is arranged on a lateral surface of the display layer 12 away from the adsorption layer 11. When the indicator 10 is mounted to the dental appliance body 101, the release paper is removed and then the indicator 10 is fixed to the dental appliance body 101, or the indicator 10 is directly molded on the dental appliance body 101.

In another embodiment, at least part of the encapsulation layer 13 is made of a material penetrable to the active substance, and the active substance in the oral cavity comes into contact with the adsorption layer 11 through the material penetrable to the active substance. In this case, the encapsulation layer 13 may include no through-hole.

Specifically, the encapsulation layer 13 arranged corresponding to the adsorption layer 11 may be made of the material penetrable to the active substance, and the encapsulation layer 13 in another area may be made of a material for isolating the active substance. In this way, the active substance in the oral cavity may be controlled to come into contact with only the adsorption layer 11 through the material penetrable to the active substance, to prevent the active substance from directly coming into contact with the display layer 12, but the present invention is not limited thereto.

A plurality of specific examples of the dental appliance 100 having the indicator 10 in the first embodiment are introduced below.

In a first specific example, with reference to FIG. 2 and FIG. 3, the display layer 12 includes a pattern layer 122 and a reaction layer 121 for blocking the pattern layer 122, and the active substance controls the reaction layer 121 to become transparent and expose the pattern layer 122.

That the reaction layer 121 blocks the pattern layer 122 means that from the perspective of an observation end, the reaction layer 121 is located on an outer side of the pattern layer 122; and when the reaction layer 121 is not changed, the reaction layer 121 blocks the pattern layer 122 to disable the pattern at the pattern layer 122 from being observed, and when the reaction layer 121 is changed and becomes transparent, the pattern presented by the pattern layer 122 can be observed through the reaction layer 121.

The reaction layer 121 is made of a material becoming transparent after coming into contact with water. For example, the reaction layer 121 is made of a material whose refractive index and/or reflected light wavelength and/or crystalline state is changed after absorbing water to become transparent.

The display layer 12 is a structure having a display function. For example, the display layer 12 has a specific color or specific pattern.

When the adsorption layer 11 reaches the saturated state, the active substance penetrates into the reaction layer 121 to enable the reaction layer 121 to become transparent and expose the pattern layer 122. When the pattern presented by the pattern layer 122 is observed, it indicates that the indicator 10 has been fully worn.

The reaction layer 121 in this example becomes transparent and exposes the pattern layer 122 only when the adsorption layer 11 reaches the saturated state, which can greatly improve indication accuracy of the indicator 10.

In another example, the reaction layer 121 is configured to become transparent when the adsorbed active substance reaches a saturated state.

When the active substance adsorbed by the reaction layer 121 has not reached the saturated state, the reaction layer 121 does not become transparent or the reaction layer 121 has not become completely transparent, and the active substance has not penetrated into the pattern layer 122. When the active substance adsorbed by the reaction layer 121 reaches the saturated state, the reaction layer 121 is completely transparent, and then the active substance penetrates into the pattern layer 122.

In addition, the pattern layer 122 may be configured to present a pattern under the action of the active substance. That is to say, when the active substance adsorbed by the reaction layer 121 reaches the saturated state, the active substance penetrates into the pattern layer 122 to enable the pattern layer 122 to present a pattern. For example, the pattern layer 122 changes color, or presents a hidden pattern.

In this example, the reaction layer 121 and the pattern layer 122 are both located on a side of an outer surface 1011 of the dental appliance body 101, the adsorption layer 11 is connected to the reaction layer 121, and the adsorption layer 11 is located on a side of the reaction layer 121 away from teeth.

“A side of an outer surface 1011 of the dental appliance body 101” refers to a side away from the cavity S.

In a direction Y from being close to the cavity S to being away from the cavity S, the pattern layer 122, the reaction layer 121, and the adsorption layer 11 in this example are sequentially stacked and connected to each other, and the encapsulation layer 13 encapsulates all of the pattern layer 122, the reaction layer 121, and the adsorption layer 11.

The pattern layer 122, the reaction layer 121, the adsorption layer 11, and the encapsulation layer 13 may be formed through spraying, lithography, screen printing, injection molding, extrusion molding, or hot-press molding.

In this example, the adsorption layer 11 is a transparent layer, and after adsorbing the active substance, the adsorption layer 11 is still a transparent layer.

The adsorption layer 11 is located between the reaction layer 121 and the oral cavity to isolate the reaction layer 121 from the oral cavity, and the active substance sequentially enters the adsorption layer 11 and the reaction layer 121 in a superposition direction of the adsorption layer 11, the reaction layer 121, and the pattern layer 122. When the reaction layer 121 is changed and becomes transparent, because the adsorption layer 11 and the reaction layer 121 are both transparent, the pattern presented by the pattern layer 122 can be observed from a side of the outer surface 1011 of the dental appliance body 101.

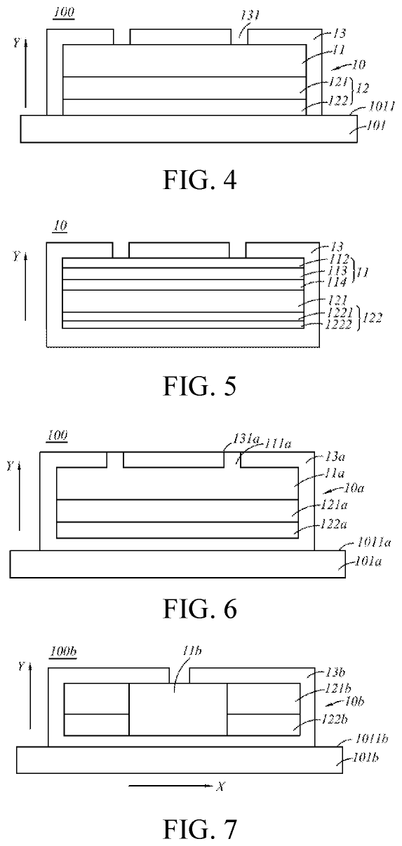

In this example, the encapsulation layer 13 is located between the pattern layer 122 and the dental appliance body 101, and a lateral surface of the encapsulation layer 13 away from the pattern layer 122 and the dental appliance body 101 are fixed to each other. Certainly, in another example, with reference to FIG. 4, the pattern layer 122 may alternatively be directly connected to the dental appliance body 101, that is, the encapsulation layer 13 under the pattern layer 122 is removed.

It should be noted that, in another example, at least one of the adsorption layer 11, the reaction layer 121, and the pattern layer 122 is a multi-layer structure.

That is to say, the adsorption layer 11 may be a single-layer structure or a multi-layer structure. Similarly, the reaction layer 121 may be a single-layer structure or a multi-layer structure, and the pattern layer 122 may be a single-layer structure or a multi-layer structure.

In addition, in a case of a multi-layer structure, the multi-layer structure may be a plurality of layers whose materials and functions are the same, or a plurality of layers whose materials or functions are different.

Specifically, with reference to FIG. 5, the adsorption layer 11 includes three layers of adsorption layers 112, 113, and 114 that are sequentially superposed, thicknesses, sizes, materials, porosities, and the like of the three layers of adsorption layers 112, 113, and 114 may be arbitrarily selected according to an actual need, and adsorption capabilities of the three layers of adsorption layers 112, 113, and 114 may be the same or different. For example, different adsorption capabilities of the three layers of adsorption layers 112, 113, and 114 correspond to different adsorption saturated times. In this way, different adsorption layers may be selected according to an actual wearing time that needs to be indicated.

It can be understood that the quantity of adsorption layers 11 may be determined according to an actual situation, and a bonding layer or another structure layer may be further included between adjacent adsorption layers.

The reaction layer 121 is a single-layer structure, but is not limited thereto.

The pattern layer 122 includes two layers of pattern layers 1221 and 1222 that are sequentially superposed, and patterns, colors, sizes, materials, and the like of the two layers of pattern layers 1221 and 1222 may be arbitrarily selected according to an actual situation. When the pattern layer 122 is displayed, only one layer of pattern layer may be displayed, or the two layers of pattern layers 1221 and 1222 are displayed simultaneously, or the two layers of pattern layers 1221 and 1222 are sequentially displayed. For example, the size of the upper layer of pattern layer 1221 is less than the size of the lower layer of pattern layer 1222 and the two layers of pattern layers 1221 and 1222 are simultaneously displayed, the lower layer of pattern layer 1222 is displayed on a peripheral edge of the upper layer of pattern layer 1221, or the upper layer of pattern layer 1221 has a hollow-out area for exposing the lower layer of pattern layer 1222.

Refer to FIG. 6, which is a schematic diagram of a dental appliance 100a having an indicator 10a according to a second specific example. For ease of description, the same or similar reference numeral is used in this example for a structure the same as or similar to that in the first specific example, similarly hereinafter.

In the second specific example, the indicator 10a includes a pattern layer 122a, a reaction layer 121a, and an adsorption layer 11a that are sequentially stacked.

The adsorption layer 11a is a transparent layer. When the reaction layer 121a is changed and becomes transparent, a pattern presented by the pattern layer 122a can be observed from a side of an outer surface 1011a of a dental appliance body 101a.

An encapsulation layer 13a encapsulates the adsorption layer 11a, the reaction layer 121a, and the pattern layer 122a, and the encapsulation layer 13a is provided with a through-hole 131a for connecting the adsorption layer 11a to an oral cavity.

The adsorption layer 11a extends into the through-hole 131a.

Specifically, the adsorption layer 11a has a protrusion 111a extending in a direction facing the through-hole 131a, the protrusion 111a fills the through-hole 131a, and the top of the protrusion 111a is flush with a top surface of the encapsulation layer 13a. In this way, an active substance in the oral cavity can be effectively prevented from entering the indicator 10a directly from a gap between the adsorption layer 11a and the encapsulation layer 13a to come into contact with the reaction layer 121a. In other words, this example may effectively control the active substance in the oral cavity to first penetrate through the adsorption layer 11a and then into the reaction layer 121a.

For other descriptions of the dental appliance 100a in the second specific example, reference may be made to descriptions the foregoing or the following specific examples, and details are not described again herein.

Refer to FIG. 7, which is a schematic diagram of a dental appliance 100b according to a third specific example.

In the third specific example, an indicator 10b includes an adsorption layer 11b and a reaction layer 121b located on a peripheral edge of the adsorption layer 11b.

Specifically; the reaction layer 121b is circumferentially connected to the peripheral edge of the adsorption layer 11b. Certainly, in another example, the reaction layer 121b may be arranged on only a side of the adsorption layer 11b.

A pattern layer 122b is located between an outer surface 1011b of a dental appliance body 101b and the reaction layer 121b, and the reaction layer 121b blocks the pattern layer 122b.

An encapsulation layer 13b encapsulates the adsorption layer 11b, the reaction layer 121b, and the pattern layer 122b, and the encapsulation layer 13b is located between the reaction layer 121b and an oral cavity to isolate the reaction layer 121b from the oral cavity.

The adsorption layer 11b and the reaction layer 121b are connected to each other in a teeth arrangement direction X (that is, a direction parallel to the outer surface 1011b of the dental appliance body 101b). When the adsorption layer 11b reaches a saturated state, an active substance penetrates into the reaction layer 121b in the teeth arrangement direction X, the reaction layer 121b is changed and becomes transparent, and a pattern presented by the pattern layer 122b may be observed from a side of the reaction layer 121b.

In this case, the adsorption layer 11b may be a transparent layer or a non-transparent layer. When the adsorption layer is a non-transparent layer, the pattern layer 122b may alternatively extend beyond the bottom of the adsorption layer 11b.

For other descriptions of the dental appliance 100b in the third specific example, reference may be made to descriptions the foregoing or the following specific examples, and details are not described again herein.

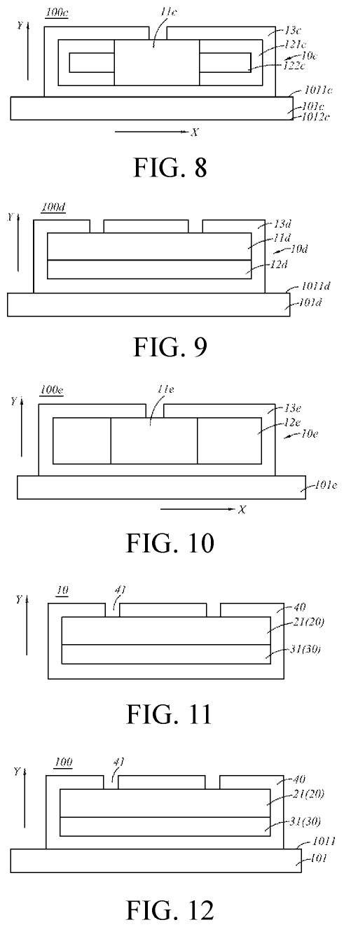

Refer to FIG. 8, which is a schematic diagram of a dental appliance 100c according to a fourth specific example.

In the fourth specific example, an indicator 10c includes an adsorption layer 11c and a reaction layer 121c located on a peripheral edge of the adsorption layer 11c.

Specifically, the reaction layer 121c is circumferentially connected to the peripheral edge of the adsorption layer 11c, and the reaction layer 121c is located on two opposite sides of a pattern layer 122c, that is, the pattern layer 122c is sandwiched in the reaction layer 121c.

An encapsulation layer 13c encapsulates the adsorption layer 11c, the reaction layer 121c, and the pattern layer 122c, and the encapsulation layer 13c is located between the reaction layer 121c and an oral cavity to isolate the reaction layer 121c from the oral cavity.

The adsorption layer 11c and the reaction layer 121c are connected to each other in a teeth arrangement direction X. When the adsorption layer 11c reaches a saturated state, an active substance penetrates into the reaction layer 121c located on upper and lower sides of the pattern layer 122c in the teeth arrangement direction X, the reaction layer 121c is changed and becomes transparent, and a pattern presented by the pattern layer 122c may be observed from both a side of an outer surface 1011c and a side of an inner surface 1012c of a dental appliance body 101c.

In this example, when the reaction layer 121c is not changed, the reaction layer 121c blocks two opposite surfaces of the pattern layer 122c, so that the pattern layer 122c is completely invisible, and an observation error may be avoided.

For other descriptions of the dental appliance 100c in the fourth specific example, reference may be made to descriptions the foregoing or the following specific examples, and details are not described again herein.

Refer to FIG. 9, which is a schematic diagram of a dental appliance 100d according to a fifth specific example.

In the fifth specific example, an indicator 10d includes an adsorption layer d and a display layer 12d that are stacked.

The display layer 12d is a single-layer structure, the adsorption layer d is connected to the display layer 12d, the adsorption layer d is located on a side of the display layer 12d away from teeth, and the display layer 12d is close to a dental appliance body 101d.

An encapsulation layer 13d encapsulates both the display layer 12d and the adsorption layer 11d, and the encapsulation layer 13d is located between the adsorption layer 11d and an oral cavity to isolate the adsorption layer 11d from the oral cavity.

In this example, the adsorption layer d is a transparent layer, and after adsorbing the active substance, the adsorption layer 11d is still a transparent layer.

The display layer 12d is a structure that is changed under the action of the active substance. For example, the display layer 12d changes color under the action of the active substance. Specifically, when the display layer 12d does not come into contact with the active substance, the display layer 12d displays a first color: or when the display layer 12d comes into contact with the active substance, the display layer 12d is changed to a second color.

Alternatively, the display layer 12d fades under the action of the active substance. Specifically, when the display layer 12d does not come into contact with the active substance, the display layer 12d displays a specific color: or when the display layer 12d comes into contact with the active substance, the display layer 12d fades. In this case, the display layer 12d may be, for example, a starch-iodine inclusion complex, and the starch-iodine inclusion complex decomposes and fades only under the action of a saliva starch enzyme in saliva, which may prevent a carbonate beverage or another active substance from affecting a fading process of the display layer 12d.

Alternatively, the display layer 12d displays a pattern under the action of the active substance. Specifically, when the display layer 12d does not come into contact with the active substance, a pattern at the display layer 12d is not displayed: or when the display layer 12d comes into contact with the active substance, the display layer 12d displays a pattern.

Certainly, the change occurring in the display layer 12d under the action of the active substance is not limited to the foregoing descriptions.

The adsorption layer d is located between the display layer 12d and the oral cavity to isolate the display layer 12d from the oral cavity, and the active substance sequentially enters the adsorption layer 11d and the display layer 12d in a superposition direction of the adsorption layer d and the display layer 12d. When the display layer 12d is changed, because the adsorption layer d is transparent, a pattern presented by the display layer 12d may be observed from a side of an outer surface 1011d of the dental appliance body 101d.

Compared with the foregoing examples, the display layer 12d in this example is a single-layer structure, so that the whole structure of the indicator 10d is simpler.

For other descriptions of the dental appliance 100d in the fifth specific example, reference may be made to descriptions the foregoing or the following specific examples, and details are not described again herein.

Refer to FIG. 10, which is a schematic diagram of a dental appliance 100e according to a sixth specific example.

In the sixth specific example, a display layer 12e is a single-layer structure, and the display layer 12e is circumferentially connected to a peripheral edge of an adsorption layer 11e.

An encapsulation layer 13e encapsulates both the display layer 12e and the adsorption layer 11e, and the encapsulation layer 13e is located between the display layer 12e and an oral cavity to isolate the display layer 12e from the oral cavity.

The adsorption layer 11e and the display layer 12e are connected to each other in a teeth arrangement direction X. When the adsorption layer 11e reaches a saturated state, an active substance penetrates into the display layer 12e in the teeth arrangement direction X, the display layer 12e is changed and presents a pattern.

In this case, the adsorption layer Ile may be a transparent layer or a non-transparent layer. When the adsorption layer is a non-transparent layer, the display layer 12e may alternatively extend beyond the bottom of the adsorption layer 11e.

For other descriptions of the dental appliance 100e in the sixth specific example, reference may be made to descriptions the foregoing or the following specific examples, and details are not described again herein.

In the first embodiment, the dental appliance 100 may alternatively include a plurality of indicators 10 that are stacked, and the plurality of indicators 10 may sequentially present patterns and indicate a plurality of wearing times. For details, reference may be made to the following second embodiment.

Refer to FIG. 11 and FIG. 12, which are schematic diagrams of an indicator 10 and a dental appliance 100 according to a second embodiment of the present invention.

For ease of description, the same or similar reference numeral is used in the second embodiment for a structure the same as or similar to that in the first embodiment, similarly hereinafter.

In the second embodiment, the indicator 10 includes a first indicator 20 and a second indicator 30 that are stacked.

The first indicator 20 includes a first pattern layer 21, the second indicator 30 includes a second pattern layer 31, and an active substance in an oral cavity sequentially penetrates through the first indicator 20 and the second indicator 30 and acts on the first pattern layer 21 and the second pattern layer 31 to sequentially present patterns.

The active substance in the oral cavity gradually penetrates in a stacking direction of the first indicator 20 and the second indicator 30. As the active substance in the oral cavity penetrates, the first pattern layer 21 and the second pattern layer 31 sequentially present patterns, which may indicate a plurality of wearing time nodes.

Specifically, assuming that the first pattern layer 21 presents a pattern after 7 days of wearing and the second pattern layer 31 presents a pattern after 14 days of wearing, that is, the first pattern layer 21 indicates a wearing time node of 7 days and the second pattern layer 31 indicates a wearing time node of 14 days, a wearing time of the dental appliance 100 may be determined by observing a presented pattern, which may adapt to dental appliances 100 with different needs.

It can be understood that this embodiment is described using an example in which the indicator 10 has the first indicator 20 and the second indicator 30. In another embodiment, the dental appliance 100 may alternatively include a third indicator.

In addition, for a specific form of a presented pattern, reference may be made to the first embodiment, and details are not described again herein.

In this embodiment, the indicator 10 further includes an encapsulation layer 40 for encapsulating the first indicator 20 and the second indicator 30.

The encapsulation layer 40 may be made of a material for isolating the active substance, the encapsulation layer 40 is provided with a through-hole 41 for connecting the first indicator 20 to the oral cavity, and the active substance in the oral cavity comes into contact with the first indicator 20 through the through-hole 41 on the encapsulation layer 40.

Alternatively, at least part of the encapsulation layer 40 is made of a material penetrable to the active substance, and the active substance in the oral cavity comes into contact with the first indicator 20 through the material penetrable to the active substance. In this case, the encapsulation layer 40 may include no through-hole.

For other descriptions of the encapsulation layer 40 in this embodiment, reference may be made to the first embodiment, and details are not described again herein.

It can be understood that a wearing time indicated by each indicator 10 may be adjusted through the quantity and size of through-holes 41 on the encapsulation layer 40, and the material and thickness of the pattern layer.

In this embodiment, the first pattern layer 21 may be directly connected to the second pattern layer 31, or the first pattern layer 21 is indirectly connected to the second pattern layer 31.

That is to say, the first indicator 20 may include only the first pattern layer 21 or the first indicator 20 further includes another function layer, and similarly the second indicator 30 may include only the second pattern layer 31 or the second indicator 30 further includes another function layer.

A plurality of specific examples of the dental appliance 100 in the second embodiment are introduced below:

In a first specific example, with reference to FIG. 12, a first indicator 20 is located on a side of a second indicator 30 away from teeth.

The first indicator 20 includes only a first pattern layer 21, the second indicator 30 includes only a second pattern layer 31, and the first pattern layer 21 is connected to the second pattern layer 31.

In this example, the first pattern layer 21 and the second pattern layer 31 are both located on a side of an outer surface 1011 of the dental appliance body 101, the second pattern layer 31 is close to the dental appliance body 101, and the first pattern layer 21 is located on a side of the second pattern layer 31 away from teeth. That is to say, in a direction Y from being close to a cavity S to being away from the cavity S, the second pattern layer 31 and the first pattern layer 21 in this example are sequentially stacked and connected to each other.

An encapsulation layer 40 encapsulates both the first pattern layer 21 and the second pattern layer 31, and the encapsulation layer 40 is located between the first pattern layer 21 and an oral cavity to isolate the second pattern layer 31 from the oral cavity.

In this example, the first pattern layer 21 blocks the second pattern layer 31, and description is made using an example in which the first pattern layer 21 and the second pattern layer 31 include different starch-iodine inclusion complexes. The starch-iodine inclusion complexes gradually fade under the action of a saliva starch enzyme in saliva. In another example, the pattern layer may be made of another material.

The first pattern layer 21 is made of a dextrin-iodine inclusion complex, and when the first pattern layer 21 presents no pattern, the first pattern layer 21 presents a red color.

The second pattern layer 31 is made of an amylopectin-iodine inclusion complex, and when the second pattern layer 31 presents no pattern, the second pattern layer 31 presents a purplish red color.

When the saliva in the oral cavity does not enter the encapsulation layer 40, only the red color presented by the first pattern layer 21 may be observed on a side of the outer surface 1011 of the dental appliance body 101.

When the saliva in the oral cavity enters the encapsulation layer 40, the saliva first comes into contact with the first pattern layer 21, the first pattern layer 21 has the red color gradually fading and becomes transparent, until the purplish red color presented by the second pattern layer 31 is observed. This case may indicate that the dental appliance 100 has been worn to a first time node.

Then, the saliva penetrates into the second pattern layer 31, the purplish red color of the second pattern layer 31 gradually fades, until completely fades. This case may indicate that the dental appliance 100 has been worn to a second time node.

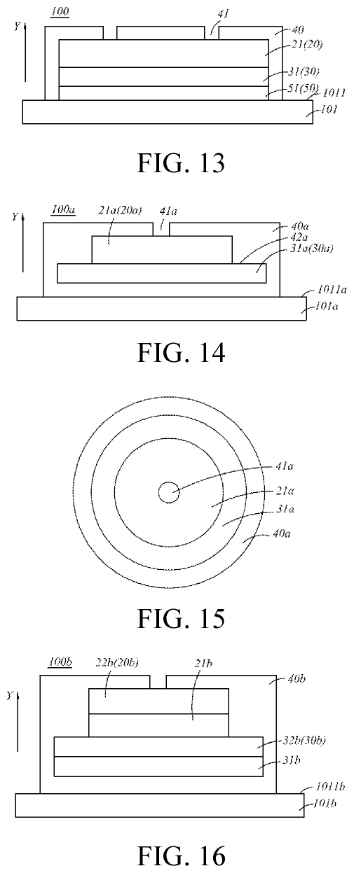

With reference to FIG. 13, the dental appliance 100 may further include a third indicator 50, the third indicator 50 includes only a third pattern layer 51, and the third pattern layer 51 is made of an amylose-iodine inclusion complex. When the third pattern layer 51 presents no pattern, the third pattern layer 51 presents a blue color.

For other descriptions of the third indicator 50, reference may be made to the foregoing descriptions, and details are not described again herein. By arranging the third indicator 50, the quantity of time nodes that the dental appliance 100 may indicate may be further increased.

Refer to FIG. 14 and FIG. 15, which are schematic diagrams of a dental appliance 100a according to a second specific example.

In the second specific example, a first indicator 20a is located on a side of a second indicator 30a away from teeth.

The first indicator 20a includes only a first pattern layer 21a, the second indicator 30a includes only a second pattern layer 31a, the second pattern layer 31a is close to a dental appliance body 101a, the first pattern layer 21a is located on a side of the second pattern layer 31a away from the teeth, and the first pattern layer 21a is connected to the second pattern layer 31a.

Cross-sections of both the first pattern layer 21a and the second pattern layer 31a are circular, the first pattern layer 21a and the second pattern layer 31a are concentrically circular, and the size of the second pattern layer 31a is greater than the size of the first pattern layer 21a. In this case, an outer contour of the second pattern layer 31a is located on an outer side of an outer contour of the first pattern layer 21a.

An encapsulation layer 40a encapsulates both the first pattern layer 21a and the second pattern layer 31a, and the encapsulation layer 40a is located between the first pattern layer 21a and an oral cavity to isolate the second pattern layer 31a from the oral cavity.

It should be noted that in this case, a step portion 42a is formed in edge areas of the first pattern layer 21a and the second pattern layer 31a, the encapsulation layer 40a may fill the step portion 42a to avoid a case that an active substance in the oral cavity directly comes into contact with the second pattern layer 31a without passing through the first pattern layer 21a.

Certainly, no structure may alternatively be arranged at the step portion 42a. Instead, a through-hole 41a of the encapsulation layer 40a is arranged to connect to only the first pattern layer 21a, and the encapsulation layer 40a and the first pattern layer 21a tightly fit to prevent the active substance from entering the step portion 42a.

In this example, description is made using an example in which the first pattern layer 21a and the second pattern layer 31a may generate different colors under the action of the active substance. In another example, the pattern layer may alternatively present different patterns, and the pattern layer may alternatively be made of another material. For example, the pattern layer is made of the starch-iodine inclusion complex in the foregoing examples.

When the active substance in the oral cavity has not entered the encapsulation layer 40a, color presentation is not observed on a side of an outer surface 1011a of the dental appliance body 101a.

When the active substance in the oral cavity enters the encapsulation layer 40a, the active substance first comes into contact with the first pattern layer 21a, and the first pattern layer 21a presents a first color, until the first color fills the first pattern layer 21a, that is, the first color fills an inner circle. This case may indicate that the dental appliance 100a has been worn to a first time node.

Then, the active substance penetrates into the second pattern layer 31a, and the second pattern layer 31a presents a second color, until the second color fills the second pattern layer 31a, that is, the second color fills an outer circular ring, while the first pattern layer 21a still maintains the first color. This case may indicate that the dental appliance 100a has been worn to a second time node.

For other descriptions of the dental appliance 100a in the second specific example, reference may be made to descriptions the foregoing or the following specific examples, and details are not described again herein.

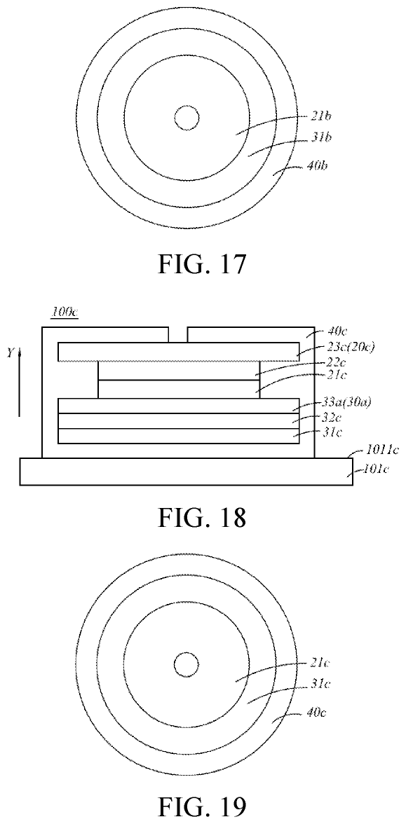

Refer to FIG. 16 and FIG. 17, which are schematic diagrams of a dental appliance 100b according to a third specific example.

In the third specific example, a first indicator 20b is located on a side of a second indicator 30b away from teeth.

The first indicator 20b further includes a first reaction layer 22b for blocking the first pattern layer 21b, the second indicator 30b further includes a second reaction layer 32b for blocking the second pattern layer 31b, and an active substance controls the first reaction layer 22b and the second reaction layer 32b to sequentially become transparent and sequentially expose the first pattern layer 21b and the second pattern layer 31b.

In this example, in a direction Y from being close to a cavity S to being away from the cavity S, the second pattern layer 31b, the second reaction layer 32b, the first pattern layer 21b, and the first reaction layer 22b are sequentially stacked and connected to each other.

An encapsulation layer 40b encapsulates all of the second pattern layer 31b, the second reaction layer 32b, the first pattern layer 21b, and the first reaction layer 22b.

The first reaction layer 22b blocks the first pattern layer 21b, and the second reaction layer 32b blocks the second pattern layer 31b. This example is an example in which the size of the first reaction layer 22b is the same as that of the first pattern layer 21b and the size of the second reaction layer 32b is the same as that of the second pattern layer 31b.

Cross-sections of both the first pattern layer 21b and the second pattern layer 31b are circular, the first pattern layer 21b and the second pattern layer 31b are concentrically circular, and the size of the second pattern layer 31b is greater than the size of the first pattern layer 21b. In this case, an outer contour of the second pattern layer 31b is located on an outer side of an outer contour of the first pattern layer 21b.

In this example, the first reaction layer 22b and the second reaction layer 32b are made of a material becoming transparent after coming into contact with water, and the first pattern layer 21b and the second pattern layer 31b have specific colors. For example, the first pattern layer 21b has a first color and the second pattern layer 31b has a second color. For details, reference may be made to the first embodiment.

When the active substance in the oral cavity has not entered the encapsulation layer 40b, color presentation is not observed on a side of an outer surface 1011b of a dental appliance body 101b.

When the active substance in the oral cavity enters the encapsulation layer 40b, the active substance first comes into contact with the first reaction layer 22b, and the first reaction layer 22b gradually becomes transparent to expose the first pattern layer 21b, that is, the first color at the first pattern layer 21b may be seen in an inner circle. This case may indicate that the dental appliance 100b has been worn to a first time node.

Then, the active substance penetrates into the second reaction layer 32b, and the second reaction layer 32b gradually becomes transparent to expose the second pattern layer 31b, that is, the second color at the second pattern layer 31b may be seen in an outer circular ring, while the first pattern layer 21b still maintains the first color. This case may indicate that the dental appliance 100b has been worn to a second time node.

In another example, the first reaction layer 22b and the second reaction layer 32b are configured to become transparent when the adsorbed active substance reaches a saturated state.

The first reaction layer 22b is used as an example. When the active substance adsorbed by the first reaction layer 22b has not reached the saturated state, the first reaction layer 22b does not become transparent, or the first reaction layer 22b has not become completely transparent, and the active substance has not penetrated into the first pattern layer 21b: or when the active substance adsorbed by the first reaction layer 22b reaches the saturated state, the first reaction layer 22b is completely transparent, and then the active substance penetrates into the first pattern layer 21b. For descriptions of the second reaction layer 32b, reference may be made to the first reaction layer 22b, and details are not described again herein.

In addition, the first pattern layer 21b and the second pattern layer 31b may be configured to present patterns under the action of the active substance.

The first pattern layer 21b is used as an example. When the active substance adsorbed by the first reaction layer 22b reaches the saturated state, the active substance penetrates into the first pattern layer 21b to enable the first pattern layer 21b to present a pattern. For example, the first pattern layer 21b changes color, or presents a hidden pattern. For descriptions of the second pattern layer 31b, reference may be made to the first pattern layer 21b, and details are not described again herein.

For other descriptions of the dental appliance 100b in the third specific example, reference may be made to descriptions the foregoing or the following specific examples, and details are not described again herein.

Refer to FIG. 18 and FIG. 19, which are schematic diagrams of a dental appliance 100c according to a fourth specific example.

In the fourth specific example, a first indicator 20c is located on a side of a second indicator 30c away from teeth.

The first indicator 20c includes a first pattern layer 21c, a first reaction layer 22c for blocking the first pattern layer 21c, and a first adsorption layer 23c connected to the first reaction layer 22c.

The second indicator 30c includes a second pattern layer 31c, a second reaction layer 32c for blocking the second pattern layer 31c, and a second adsorption layer 33c connected to the second reaction layer 32c.

When an active substance adsorbed by the first adsorption layer 23c reaches a saturated state, the active substance penetrates into the first reaction layer 22c, and the first reaction layer 22c becomes transparent to expose the first pattern layer 21c. When an active substance adsorbed by the second adsorption layer 33c reaches a saturated state, the active substance penetrates into the second reaction layer 32c, and the second reaction layer 32c becomes transparent to expose the second pattern layer 31c.

In this example, in a direction Y from being close to a cavity S to being away from the cavity S, the second pattern layer 31c, the second reaction layer 32c, the second adsorption layer 33c, the first pattern layer 21c, the first reaction layer 22c, and the first adsorption layer 23c are sequentially stacked and connected to each other.

An encapsulation layer 40c encapsulates all of the second pattern layer 31c, the second reaction layer 32c, the second adsorption layer 33c, the first pattern layer 21c, the first reaction layer 22c, and the first adsorption layer 23c, and the encapsulation layer 40c is located between the first adsorption layer 23c and an oral cavity to isolate the first reaction layer 22c from the oral cavity:

In this example, both the first adsorption layer 23c and the second adsorption layer 33c are transparent layers. Cross-sections of both the first pattern layer 21c and the second pattern layer 31c are circular, the first pattern layer 21c and the second pattern layer 31c are concentrically circular, and the size of the second pattern layer 31c is greater than the size of the first pattern layer 21c. In this case, an outer contour of the second pattern layer 31c is located on an outer side of an outer contour of the first pattern layer 21c.

In this example, the first reaction layer 22c and the second reaction layer 32c are made of a material becoming transparent after coming into contact with water, and the first pattern layer 21c and the second pattern layer 31c have specific colors. For example, the first pattern layer 21c has a first color and the second pattern layer 31c has a second color. For details, reference may be made to the first embodiment.

When the active substance in the oral cavity has not entered the encapsulation layer 40c, color presentation is not observed on a side of an outer surface 1011c of a dental appliance body 101c.

When the active substance in the oral cavity enters the encapsulation layer 40c, the active substance first comes into contact with the first adsorption layer 23c. When the first adsorption layer 23c reaches the saturated state, the active substance penetrates into the first reaction layer 22c, and the first reaction layer 22c gradually becomes transparent to expose the first pattern layer 21c, that is, the first color at the first pattern layer 21c may be seen in an inner circle. This case may indicate that the dental appliance 100c has been worn to a first time node.

Then, the active substance penetrates into the second adsorption layer 33c. When the second adsorption layer 33c reaches the saturated state, the active substance penetrates into the second reaction layer 32c, and the second reaction layer 32c gradually becomes transparent to expose the second pattern layer 31c, that is, the second color at the second pattern layer 31c may be seen in an outer circular ring, while the first pattern layer 21c still maintains the first color. This case may indicate that the dental appliance 100c has been worn to a second time node.

For other descriptions of the dental appliance 100c in the fourth specific example, reference may be made to descriptions the foregoing or the following specific examples, and details are not described again herein.

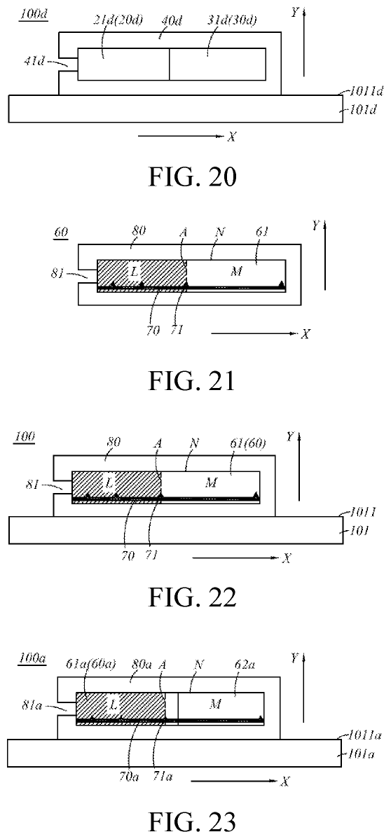

Refer to FIG. 20, which is a schematic diagram of a dental appliance 100d according to a fifth specific example.

In the fifth specific example, a first indicator 20d and a second indicator 30d are arranged side by side in a teeth arrangement direction X, that is, an arrangement direction of the first indicator 20d and the second indicator 30d is parallel to an outer surface 1011d of a dental appliance body 101d.

The first indicator 20d includes only a first pattern layer 21d, the second indicator 30d includes only a second pattern layer 31d, and the first pattern layer 21d is connected to the second pattern layer 31d.

An encapsulation layer 40d encapsulates both the first pattern layer 21d and the second pattern layer 31d, the encapsulation layer 40d is provided with a through-hole 41d for connecting an oral cavity to the first pattern layer 21d, and an opening direction of the through-hole 41d is parallel to the outer surface 1011d of the dental appliance body 101d.

In this example, the first pattern layer 21d isolates a passage through which the active substance comes into contact with the second pattern layer 31d, and description is made using an example in which the first pattern layer 21d and the second pattern layer 31d include different starch-iodine inclusion complexes. In another example, the pattern layer may be made of another material.

The first pattern layer 21d is made of a dextrin-iodine inclusion complex, and when the first pattern layer 21d presents no pattern, the first pattern layer 21d presents a red color.

The second pattern layer 31d is made of an amylopectin-iodine inclusion complex, and when the second pattern layer 31d presents no pattern, the second pattern layer 31d presents a purplish red color.

When the saliva in the oral cavity does not enter the encapsulation layer 40d, the red color presented by the first pattern layer 21d and the purplish red color presented by the second pattern layer 31d may be observed simultaneously on a side of the outer surface 1011d of the dental appliance body 101d, and a red area and a purplish red area are arranged in a straight line.

When the saliva in the oral cavity enters the encapsulation layer 40d, the saliva first comes into contact with the first pattern layer 21d, the first pattern layer 21d has the red color gradually fading, until only the purplish red color presented by the second pattern layer 32d may be observed. This case may indicate that the dental appliance 100d has been worn to a first time node.

Then, the saliva penetrates into the second pattern layer 31d, the purplish red color of the second pattern layer 31d gradually fades, until completely fades. This case may indicate that the dental appliance 100d has been worn to a second time node.

For other descriptions of the dental appliance 100d in the fifth specific example, reference may be made to descriptions the foregoing or the following specific examples, and details are not described again herein.

It should be noted that the indicator in the second embodiment may alternatively be another structure in the first embodiment, and is not limited to the foregoing descriptions.

Refer to FIG. 21 and FIG. 22, which are schematic diagrams of an indicator 60 and a dental appliance 100 according to a third embodiment of the present invention.

In the third embodiment, the indicator 60 includes a pattern layer 61 and a scale 70, and the pattern layer 61 generates a changed area L under the action of an active substance in an oral cavity.

The scale 70 is used for indicating location information of the changed area L.

Assuming that the pattern layer 61 forms an observation area N, when the dental appliance 100 is worn in the oral cavity, the pattern layer 61 is changed to enable the observation area N to include the changed area L and an unchanged area M, and the changed area L is, for example, a color changing area or a fading area.

As the wearing time of the dental appliance 100 extends, a junction location A between the changed area L and the unchanged area M is changed, and the scale 70 is used for indicating location information of the junction location A, that is, the wearing time of the dental appliance 100 may be indicated by the scale 70.

In other words, in this embodiment, by arranging the scale 70 used in collaboration with the pattern layer 61, the wearing time of the dental appliance 100 may be indicated in real time.

In this embodiment, the indicator 60) is mounted on an outer surface 1011 of the dental appliance body 101, the pattern layer 61 changes color in a first direction X and generates the changed area L, and the first direction X is parallel to the outer surface 1011, so that it is convenient to observe and indicate the location information of the changed area L.

It should be noted that “the pattern layer 61 changes color in the first direction X” means that the observed pattern layer 61 changes color in the first direction X, an actual penetration direction of the active substance in the oral cavity may be the first direction X or a direction perpendicular to the first direction X, for example, a direction from being away from a cavity S to being close to the cavity S (that is, an opposite direction of a direction Y).

In this embodiment, description is made using an example in which the first direction X is a teeth arrangement direction.

The scale 70 extends in the first direction X, and the scale has a mark 71 for indicating the junction location A between the changed area L and the unchanged area M. For the mark 71. refer to an arrow area in FIG. 21.

In the first direction X, a plurality of marks 71 are formed on the scale 70, and the plurality of marks 71 are used for indicating a plurality of different wearing times.

For example, four marks 71 are sequentially formed on the scale 70 in the first direction X, and the four marks 71 sequentially indicate that wearing times are 3 days, 7 days, 14 days, and 28 days. In this way, the wearing time of the dental appliance 100 may be determined by observing a relationship between the marks 71 and the junction location A, and a wearing time indication process is simpler and more direct.

In addition, the scale 70 is connected to the pattern layer 61 and is located on a lateral side of the pattern layer 61. In another example, the scale 70 may be located on the pattern layer 61. that is, the scale 70 is located on a side of the pattern layer 61 away from the outer surface 1011 of the dental appliance body 101. Certainly, in another embodiment, the scale 70 and the pattern layer 61 may alternatively be spaced apart on the outer surface 1011 of the dental appliance body 101.

It can be understood that the scale 70 may alternatively be in another form, as long as it is ensured that the wearing time of the dental appliance 100 may be indicated.

In this embodiment, the indicator 60 further includes an encapsulation layer 80 for encapsulating at least the pattern layer 61.

The encapsulation layer 80 may be made of a material for isolating the active substance, the encapsulation layer 80 is provided with a through-hole 81 for connecting the pattern layer 61 to the oral cavity, and the active substance in the oral cavity comes into contact with the pattern layer 61 through the through-hole 81 on the encapsulation layer 80.

Alternatively, at least part of the encapsulation layer 80 is made of a material penetrable to the active substance, and the active substance in the oral cavity comes into contact with the pattern layer 61 through the material penetrable to the active substance. In this case, the encapsulation layer 80 may include no through-hole.

The scale 70 may be located outside or inside the encapsulation layer 80. For other descriptions of the encapsulation layer 80, reference may be made to the first embodiment, and details are not described again herein.

A plurality of specific examples of the dental appliance 100 having the indicator 60 in the third embodiment are introduced below:

In a first specific example, with reference to FIG. 22, an indicator 60 includes only one pattern layer 61, and description is made using an example in which the pattern layer 61 is a starch-iodine inclusion complex. The starch-iodine inclusion complexes gradually fade under the action of a saliva starch enzyme in saliva. In another example, the pattern layer may be made of another material.

An encapsulation layer 80 encapsulates the pattern layer 61, and an opening direction of a through-hole 81 on the encapsulation layer 80 is a first direction X.

The pattern layer 61 is made of a dextrin-iodine inclusion complex, and when the pattern layer 61 presents no pattern, the pattern layer 61 presents a red color.

When the saliva in the oral cavity does not enter the encapsulation layer 80, it may be observed on a side of the outer surface 1011 of the dental appliance body 101 that an entire observation area N formed at the pattern layer 61 is all in a red color.

When the saliva in the oral cavity enters the encapsulation layer 80, the saliva comes into contact with the pattern layer 61, and the red color of the pattern layer 61 gradually fades. An area whose color fades is a changed area L, an area whose color does not fade is an unchanged area M, and a junction location A is formed between the changed area L and the unchanged area M. In this case, location information of the junction location A may be read according to a mark 71 on a scale 70, and the location information may indicate the wearing time of the dental appliance 100.

Refer to FIG. 23, which is a schematic diagram of a dental appliance 100a according to a second specific example. For ease of description, the same or similar reference numeral is used in this example for a structure the same as or similar to that in the first specific example, similarly hereinafter.

In the second specific example, a pattern layer of an indicator 60a includes a first pattern layer 61a and a second pattern layer 62a that are connected to each other. description is made using an example in which each of the first pattern layer 61a and the second pattern layer 62a is a starch-iodine inclusion complex. In another example, the pattern layer may be made of another material.

An encapsulation layer 80a encapsulates the first pattern layer 61a and the second pattern layer 62a, and an opening direction of a through-hole 81a on the encapsulation layer 80a is a first direction X.

The first pattern layer 61a is made of a dextrin-iodine inclusion complex, and when the pattern layer 61a presents no pattern, the pattern layer 61a presents a red color.

The second pattern layer 62a is made of an amylopectin-iodine inclusion complex, and when the second pattern layer 62a presents no pattern, the second pattern layer 62a presents a purplish red color.

When the saliva in the oral cavity does not enter the encapsulation layer 80a, the red color presented by the first pattern layer 61a and the purplish red color presented by the second pattern layer 62a may be observed simultaneously on a side of the outer surface 1011a of the dental appliance body 101a, and an entire observation area N is a red area and a purplish red area arranged in a straight line.

When the saliva in the oral cavity enters the encapsulation layer 80a, the saliva penetrates in the first direction X and sequentially comes into contact with the first pattern layer 61a and the second pattern layer 62a. In the entire observation area N, an area whose color fades is a changed area L, an area whose color does not fade is an unchanged area M, and a junction location A is formed between the changed area L and the unchanged area M. In this case, location information of the junction location A may be read according to a mark 71a on a scale 70a, and the location information may indicate the wearing time of the dental appliance 100a.

Because there are two pattern layers in different colors, color changes of the pattern layers also have a specific indication effect on the wearing time, the wearing time may be indicated through both the color changes and readings of the scale 70a in this example, and the indication effect is better.

For other descriptions of the dental appliance 100a in the second specific example, reference may be made to descriptions the foregoing or the following specific examples, and details are not described again herein.

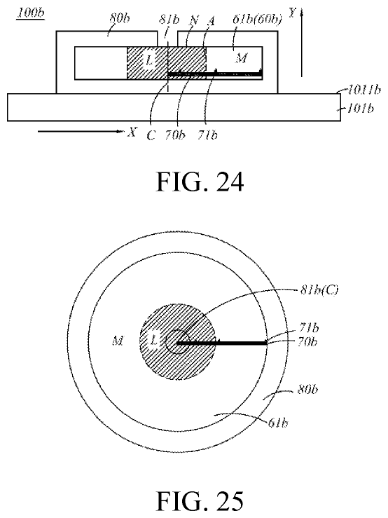

Refer to FIG. 24 and FIG. 25, which are schematic diagrams of a dental appliance 100b according to a third specific example.

In the third specific example, an indicator 60b includes only one pattern layer 61b, description is made using an example in which the pattern layer 61b is a starch-iodine inclusion complex, and the cross-section of the pattern layer 61b is circular. In another example, the pattern layer 61b may be made of another material.

An encapsulation layer 80b encapsulates the pattern layer 61b, and an opening direction of a through-hole 81b on the encapsulation layer 80b is a direction Y from being close to a cavity S to being away from the cavity S. In addition, the through-hole 81b is arranged corresponding to a center C of the pattern layer 61b. In this case, saliva first comes into contact with the center C of the pattern layer 61b.

The pattern layer 61b is made of a dextrin-iodine inclusion complex, and when the pattern layer 61b presents no pattern, the pattern layer 61b presents a red color.

When the saliva in the oral cavity does not enter the encapsulation layer 80b, it may be observed on a side of the outer surface 1011b of the dental appliance body 101b that an entire observation area N formed at the pattern layer 61b is all in a red color, and the observation area N is circular.

When the saliva in the oral cavity enters the encapsulation layer 80b, the saliva comes into contact with the center C of the pattern layer 61b, and the red color presented by the pattern layer 61b gradually fades outward radially from the center C. An area whose color fades is a changed area L, an area whose color does not fade is an unchanged area M, and a junction location A is formed between the changed area L and the unchanged area M. In this case, location information of the junction location A may be read according to a mark 71b on a scale 70b, and the location information may indicate the wearing time of the dental appliance 100b.

For other descriptions of the dental appliance 100b in the third specific example, reference may be made to descriptions the foregoing or the following specific examples, and details are not described again herein.

It should be noted that the indicator in the third embodiment may alternatively be another structure in the first or second embodiment, and is not limited to the foregoing descriptions.

In addition, cross reference may be made between embodiments to form new specific examples, and the new specific examples all fall within the protection scope of the present invention.

It should be understood that, although this specification is described according to each embodiment, each embodiment may not include only one independent technical solution. The description manner of this specification is merely for clarity. This specification should be considered as a whole by a person skilled in the art, and the technical solution in each embodiment may also be properly combined, to form other embodiments that can be understood by the person skilled in the art.

A series of detailed descriptions listed above are specific descriptions for only feasible embodiments of the present invention, and are not intended to limit the protection scope of the present invention. Any equivalent embodiment or change made without departing from the skill and spirit of the present invention should be included in the protection scope of the present invention.

1. An indicator, used for a dental appliance, wherein the indicator comprises a first indicator and a second indicator that are stacked, the first indicator comprises a first pattern layer, the second indicator comprises a second pattern layer, and an active substance in an oral cavity sequentially penetrates through the first indicator and the second indicator and acts on the first pattern layer and the second pattern layer to sequentially present patterns.

2. The indicator according to claim 1, wherein the first pattern layer is connected to the second pattern layer.

3. The indicator according to claim 2, wherein the first pattern layer and the second pattern layer comprise different starch-iodine inclusion complexes.

4. The indicator according to claim 1, wherein the first indicator further comprises a first reaction layer for blocking the first pattern layer, the second indicator further comprises a second reaction layer for blocking the second pattern layer, and the active substance controls the first reaction layer and the second reaction layer to sequentially become transparent and sequentially expose the first pattern layer and the second pattern layer.

5. The indicator according to claim 4, wherein the first reaction layer and the second reaction layer are configured to become transparent when the adsorbed active substance reaches a saturated state.

6. The indicator according to claim 4, wherein the first pattern layer and the second pattern layer are configured to present patterns under the action of the active substance.

7. The indicator according to claim 4, wherein the first indicator further comprises a first adsorption layer connected to the first reaction layer, and the second indicator further comprises a second adsorption layer connected to the second reaction layer; and when the active substance adsorbed by the first adsorption layer reaches a saturated state, the active substance penetrates into the first reaction layer, and when the active substance adsorbed by the second adsorption layer reaches a saturated state, the active substance penetrates into the second reaction layer.

8. The indicator according to claim 7, wherein the first adsorption layer, the first reaction layer, the first pattern layer, the second adsorption layer, the second reaction layer, and the second pattern layer are sequentially stacked.

9. The indicator according to claim 7, wherein both the first adsorption layer and the second adsorption layer are transparent layers.

10. The indicator according to claim 1, wherein the indicator further comprises an encapsulation layer for encapsulating the first indicator and the second indicator.

11. The indicator according to claim 10, wherein the encapsulation layer is provided with a through-hole for connecting the first indicator to the oral cavity.

12. The indicator according to claim 11, wherein the encapsulation layer is made of a material for isolating the active substance.

13. The indicator according to claim 10, wherein at least part of the encapsulation layer is made of a material penetrable to the active substance.

14. The indicator according to claim 1, wherein an outer contour of the second pattern layer is located on an outer side of an outer contour of the first pattern layer.

15. A dental appliance, worn in an oral cavity and comprising the indicator according to claim 1.

16. The dental appliance according to claim 15, wherein the dental appliance comprises a dental appliance body and the indicator arranged on the dental appliance body, and the dental appliance body forms a cavity for receiving teeth.

17. The dental appliance according to claim 16, wherein the first indicator is located on a side of the second indicator away from the teeth.

18. The dental appliance according to claim 16, wherein the first indicator and the second indicator are arranged side by side in a teeth arrangement direction.

19. The dental appliance according to claim 15, wherein the dental appliance is a shell-shaped orthodontic appliance or an orofacial muscle training appliance.

20-50. (canceled)
